(19) United States
(12) Patent Application Publication
(10) Pub. No.: US 2025/0260333 A1
(43) Pub. Date: Aug. 14, 2025

(54) BUSBAR ASSEMBLY FOR A PLURALITY OF INVERTERS

(71) Applicant: Progress Rail Services Corporation, Albertville, AL (US)

(72) Inventors: Frederico M. KLOPFFLEISCH, Curitiba/PR (BR); Willi U. DANELUZ, Curitiba/PR (BR); Fabio SAVEDRA, São Paulo/SP (BR); Gabriel B. ALVES, Curitiba/PR (BR)

(73) Assignee: Progress Rail Services Corporation, Albertville, AL (US)

(21) Appl. No.: 18/436,706

(22) Filed: Feb. 8, 2024

(51) Int. Cl. H02M 7/00

(52) U.S. Cl. CPC H02M 7/003

(57) ABSTRACT

A busbar assembly for delivering current to a plurality of inverters may include a plurality of busbars, configured to receive current from a current source and to output current to the plurality of inverters, a plurality of spacers positioned between the plurality of busbars, and a plurality of inverter connectors, each inverter connector being coupled to one of the plurality of busbars, wherein each of the plurality of spacers and the plurality of inverter connectors is formed of a conductive material.

### TECHNICAL FIELD

The present disclosure relates generally to busbars, and, more particularly, to busbar assemblies having a plurality of busbars.

### BACKGROUND

Machines, such as locomotives, use inverters to convert direct current (DC) from power sources, such as batteries, to alternating current (AC), to power components of the machines, such as a traction motor of a locomotive. Each inverter typically has its own link to the power sources, with each connection requiring conductive material, e.g., copper, which are subject to issues regarding the balance between manufacturing costs and heat management.

There is a need, therefore, to connect a plurality of traction inverters to a common busbar. However, this type of connection has high current requirements and may cause current recirculation between the inverters due to imbalances in internal capacitors. Further, such a connection may require a relatively large amount of material to form the common busbar and may create thermal inefficiency due to the building up of heat due to current passing through the common busbar.

U.S. Pat. No. 11,070,036 (“the '036 patent”) discloses multi-phase busbars for conducting alternating electrical current (AC) to different electrical devices. These busbars include a base layer of an insulating material, a first conducting layer of a sheet metal, and a first insulating layer of an insulating material arranged on the first conducting layer. The first and/or second insulating layers comprise spacers. That is, the '036 patent requires insulating material to form the insulating layers and uses multi-phase busbars for AC current.

The assemblies of the present invention address these and other problems in the art. The scope of the current disclosure, however, is defined by the attached claims, and not by the ability to solve any specific problem.

### SUMMARY

In one aspect of the present disclosure, a busbar assembly for delivering current to a plurality of inverters may include a plurality of busbars, configured to receive current from a current source and to output current to the plurality of inverters, a plurality of spacers positioned between the plurality of busbars, and a plurality of inverter connectors, each inverter connector being coupled to one of the plurality of busbars, wherein each of the plurality of spacers and the plurality of inverter connectors is formed of a conductive material.

In another aspect of the present disclosure, a busbar assembly may include a plurality of busbars including: a first busbar having a first length, a second busbar having a second length that is greater than the first length, and a third busbar having a third length that is greater than the second length. The busbar assembly may also include a plurality of spacers forming: a first spacer layer, including two or more spacers, of the plurality of spacers, positioned between the first busbar and the second busbar, and a second spacer layer, including a number of spacers that is greater than a number of spacers of the first spacer layer, of the plurality of spacers, positioned between the second busbar and the third busbar. In addition, the busbar assembly may include a plurality of inverter connectors, each inverter connector being coupled to one of the plurality of busbars, wherein each spacer of the first spacer layer and the second spacer layer and the plurality of connectors is formed of a conductive material.

In still another aspect of the present disclosure, a busbar and inverter assembly may include a busbar assembly that includes a plurality of busbars, configured to receive current from a current source and to output current, a plurality of spacers positioned between the plurality of busbars, and a plurality of inverter connectors, each inverter connector being coupled to one of the plurality of busbars, each of the plurality of spacers and the plurality of connectors being formed of a conductive material. The busbar and inverter assembly may also include a plurality of inverters, arranged in parallel and directly connected to the plurality of inverter connectors and configured to receive the current output by the plurality of busbars.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic drawing of a locomotive, as an example of a machine on which a busbar and inverter assembly according to the present invention may be installed.

FIG. 2 is a schematic view of a busbar and inverter assembly, including busbar assemblies, in accordance with the present invention.

FIG. 3 is a schematic detail view of a spacer of the busbar assemblies of FIG. 2.

FIG. 4 is a detailed cross-sectional view of a portion of one of the busbar assemblies of FIG. 2.

FIG. 5 is a schematic diagram of current flow through the busbar assembly shown in FIG. 2.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

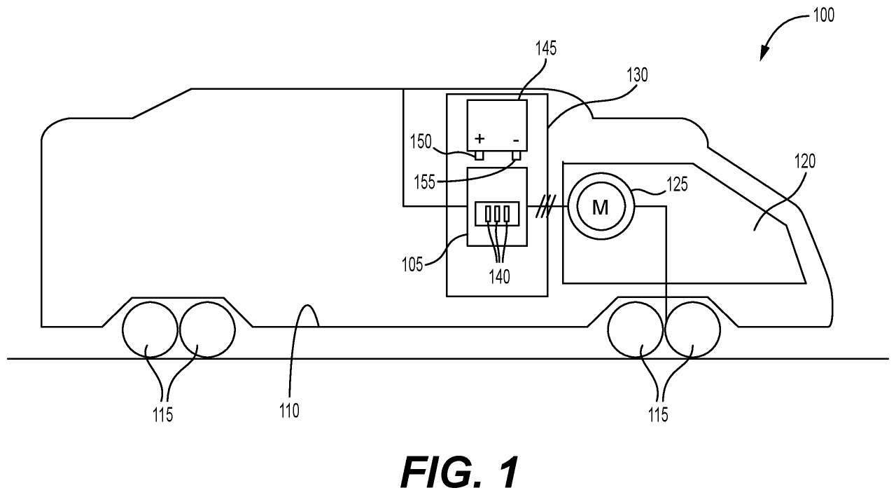

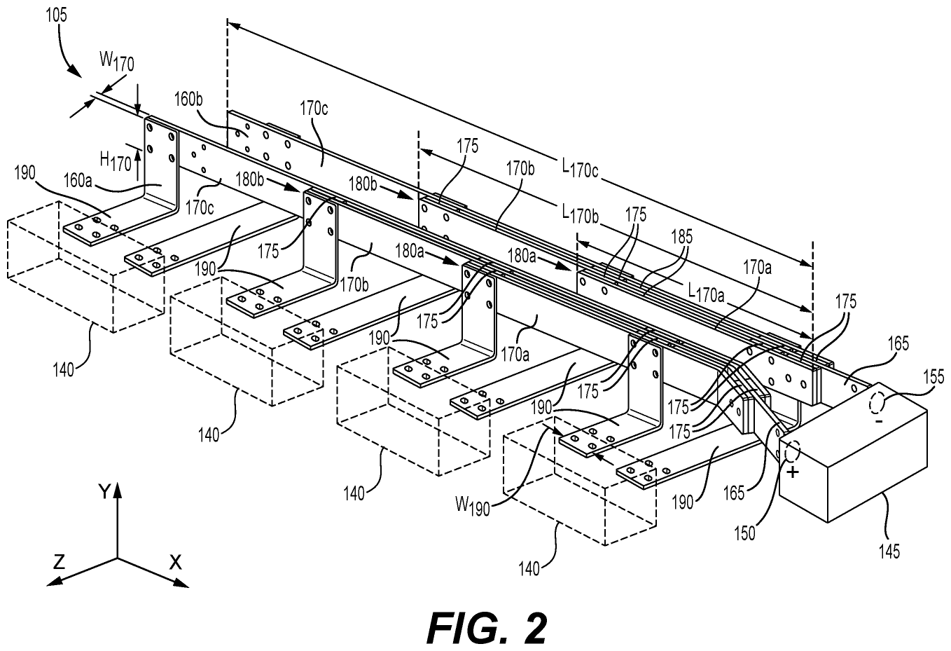

FIG. 1 shows a schematic drawing of a locomotive 100, as an example of a machine, in which a busbar and inverter assembly 105, according to the present invention, and shown in FIG. 2, may be installed. The locomotive has a chassis 110, a plurality of wheels 115, an engine compartment 120, including a motor 125, and an electronics compartment 130, among others. The electronics compartment 130 may include a plurality of inverters 140, such as traction inverters, as part of the busbar and inverter assembly 105. The electronics compartment 130 may also include at least one current source 145, such as a direct current (DC) battery, having a positive terminal 150 and a negative terminal 155.

FIG. 2 shows the busbar and inverter assembly 105, according to one embodiment of the invention, including one busbar assembly 160a with inverters 140, and one separate busbar assembly 160b without inverters 140, for simplicity. In the busbar and inverter assembly 105, the inverters 140 may be arranged in parallel, and each inverter 140 may be directly connected to the busbar assembly 160a. In the embodiment shown in FIG. 2, the busbar and inverter assembly 105 includes four inverters 140. In some embodiments, three or more inverters 140 are used. However, a lesser number or a greater number of inverters 140 may be used. The number of inverters 140 may be determined based on a number of traction motors provided on the locomotive 100. The busbar assembly 160a delivers current to the plurality of inverters 140.

Each busbar assembly 160 includes a current source port 165 for receiving a current from the current source 145 via the positive terminal 150 or the negative terminal 155. Each busbar assembly 160 also includes a plurality of busbars 170 that are configured to receive current from the current source 145 and to transmit the same amount of current through each of the busbars 170. The number of busbars 170 may be determined based on the number of inverters 140. In one embodiment, the busbars 170 may be single-pole busbars. In another embodiment, multi-ole busbars may be used. In the embodiment shown in FIG. 2, one of the busbar assemblies 160a connects to the positive terminal 150 of the current source 145, and the other of the busbar assemblies 160a connects to the negative terminal 155 of the current source 145. In each busbar assembly 160 shown in FIG. 2, the busbars 170 include a first busbar 170a, a second busbar 170b, and a third busbar 170c. The first busbar 170a may also be referred to as a top busbar, the second busbar 170b may also be referred to as a middle busbar, and the third busbar 170c may also be referred to as a bottom-most busbar. The busbars 170 may be formed of a conductive material. As one example, the conductive material may be copper.

The busbars 170 may be in a staggered arrangement, having different lengths, as measured along the x-axis. That is, a length L₁₇₀ₐ of the first busbar 170a may be less than a length L_{170b} of the second busbar 170b, and the length L₂ of the second busbar 170b may be less than a length L_{170c} of the third busbar 170c. The width of the busbars 170 may depend on the current draw of the inverter 140 to which the busbar 170 is connected. In one embodiment, the busbars 170 may have the same width W₁₇₀, measured along the x-axis, in a case in which the inverters 140 have the same width. In another embodiment, one or more of the busbars 170 may have a different width than the other busbars 170, in a case in which one or more of the inverters 140 have different widths than the other inverters 140. In addition, each of the busbars 170 has the same height H₁₇₀, measured along the y-axis. In some embodiments, a proximal end of each of the busbars 170 of a busbar assembly 160 (e.g., busbar assembly 160a of FIG. 2), the proximal end being, nearest the current source 145, may be bent, for example, to address space constraints. In some embodiments, one or both busbar assemblies 160 may include busbars 170 with bent proximal ends.

The busbar assembly 160 further includes a plurality of spacers 175, positioned in between the busbars 170, in layers 180. The spacers 175 provided in between the first busbar 170a and the second busbar 170b may be referred to as a first layer 180a, and the spacers 175 provided in between the second busbar 170b and the third busbar 170c may be referred to as a second layer 180b. In the embodiment shown in FIG. 2, three spacers 175 are provided in the first layer 180a, and four spacers 175 are provided in the second layer 180b. However, the first layer 180a and the second layer 180b may include a greater or a lesser number of spacers 175. For example, each layer 180 may include two or more spacers 175. In one embodiment, the second layer 180b may have a greater number of spacers 175 than a number of spacers in the first layer 180a. In addition, although the first layer 180a and the second layer 180b include a different number of spacers 175 than each other, the first layer 180a and the second layer 180b may include the same number of spacers 175 as each other.

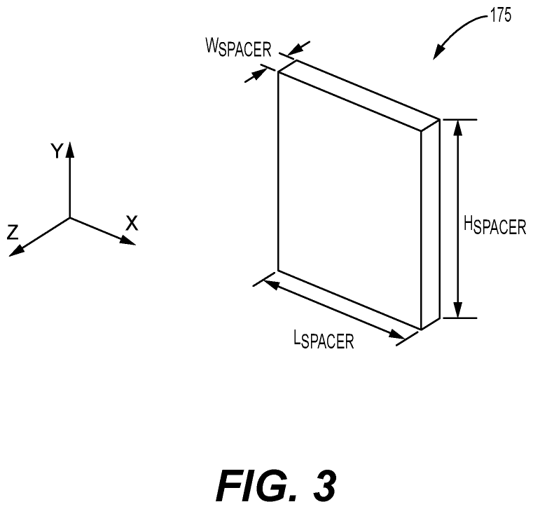

FIG. 3 shows a detail view of a spacer 175, including a length L₁₇₅, measured along the x-axis, a height H₁₇₅ measured along the y-axis, and a width W₁₇₅, measured along the z-axis. These dimensions may be the same for all of the spacers 175. Alternatively, one or more of the length L₁₇₅, the height H₁₇₅, and the width W₁₇₅ may vary among the spacers 175. Further, the spacers 175 may be equally spaced apart between the busbars 170, along the x-axis. Alternatively, the spacing between the spacers 175 along the x-axis may vary. In the embodiment shown in FIG. 2, as an example, two of the spacers 175 in the first layer 180a may be equally spaced apart, with the third, proximal-most spacer 175, nearest the current source 145, being at a relatively lesser spacing to an adjacent spacer 175. Similarly, three of the spacers 175 in the second layer 180b may be equally spaced apart, with the fourth, proximal-most spacer 175, nearest the current source 145, being at a relatively lesser spacing to an adjacent spacer 175. The spacers 175 may be formed of a conductive material. As one example, the conductive material may be copper. In between the spacers 175 and the busbars 170, openings 185 are formed. The openings 185 may be formed by virtue of welding together the busbars 170 and the spacers 175 in the configuration shown in FIG. 2, or the openings 185 may be formed by removing portions from a block of material. Each of the openings 185 is defined by surfaces of the adjacent busbars 170 and spacers 175, from which heat, generated by current passing through the busbar assembly 160 to the inverters 140, dissipates into air within the openings 185. That is, the openings 185 are not filled with a material and are left empty to promote or allow dissipation of heat from surfaces of the spacers 175 and the busbars 170.

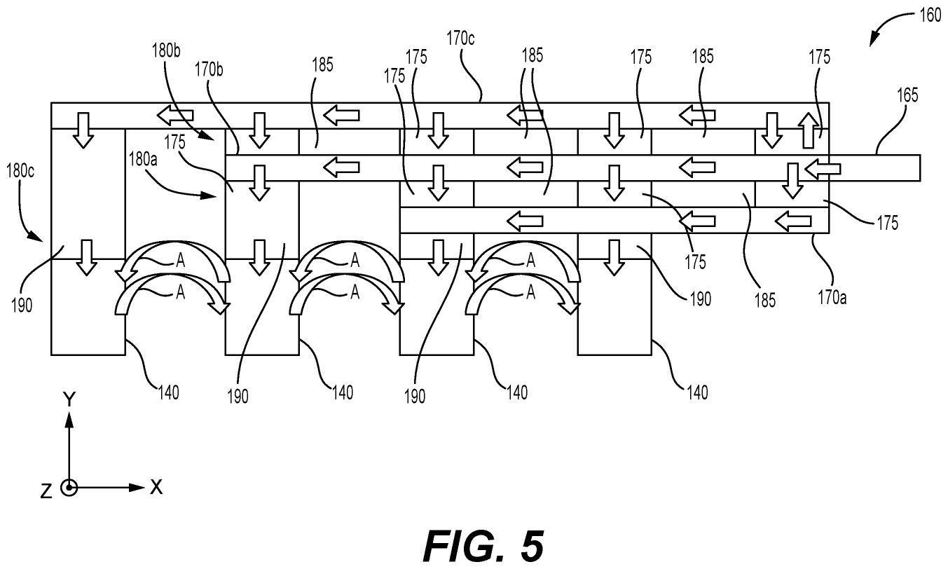

The busbar assembly 160 further includes a plurality of connectors 190, provided on one or more busbars 170. In the embodiment shown in FIG. 2, the connectors 190 are provided on all three of the first busbar 170a, the second busbar 170b, and the third busbar 170c. However, in an alternative embodiment, described below with reference to FIG. 5, the connectors 190 may be provided on only one of the busbars 170. The connectors 190 may also be considered a third layer 180 of spacers 175, specifically, a third or bottom layer 180c. Each of the connectors 190 is configured to connect the busbars 170 with the inverters 140 of the busbar and inverter assembly 105. The connectors 190 may be formed of a conductive material. As one example, the conductive material may be copper. A length L₁₉₀, measured along the x-axis, a height H₁₉₀, measured along the y-axis, and a width W₁₉₀, measured along the z-axis, may be the same for all connectors 190. Alternatively, one or more of the length L₁₉₀, the height H₁₉₀, and the width W₁₉₀ may vary among the connectors 190.

The plurality of busbars 170, the plurality of spacers 175, and the plurality of connectors 190 may be formed of the same conductive material. As one example, the busbars 170, the spacers 175, and the connectors 190 may all be formed of copper. Alternatively, one or more of the busbars 170, the spacers 175, and the connectors 190 may be formed of a different conductive material than one or both of the other of the busbars 170, the spacers 175, and the connectors 190. The busbars 170, the spacers 175, and the connectors 190 are connected to each other to form the busbar assembly 160. As one example, the busbars 170, the spacers 175, and the connectors 190 may be brazed together. The connections between the busbars 170, the spacers 175, and the connectors 190, and the use of a conductive material to form these components, create electrical connections among them, such that current flowing into the current source port 165, and through the busbars 170, the spacers 175, and the connectors 190, flows to the inverters 140.

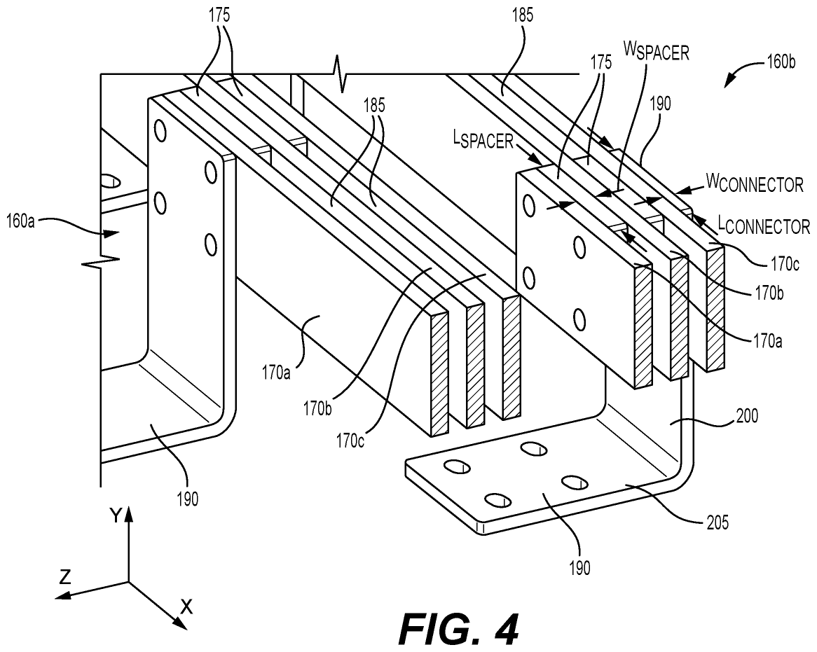

FIG. 4 is a detail cross-sectional view of a portion of one of the busbar assemblies 160 shown in FIG. 2. In particular, FIG. 4 shows the first busbar 170a, the second busbar 170b, and the third busbar 170c of the one busbar assembly 160a, and the first busbar 170a, the second busbar 170b, and the third busbar 170c of the other busbar assembly 160b, shown in FIG. 2. FIG. 4 also shows spacers 175 located in between the first busbar 170a and the second busbar 170b of each busbar assembly 160a and 160b, and in between the second busbar 170b and the third busbar 170c of each busbar assembly 160a and 160b. In addition, FIG. 4 shows connectors 190 on the third busbars 170c. The connectors 190 may have a busbar connection portion 200 for connecting to the third busbars 170c, and an inverter connection portion 205 for connecting to the inverters 140. The connectors 190 may be L-shaped, as shown in FIG. 4, with an approximate 90° angle in between the busbar connection portion 200 and the inverter connection portion 205, although the connectors 190 may be formed into other shapes.

### INDUSTRIAL APPLICABILITY

The busbar assembly 160 and the busbar and inverter assembly 105 of the present invention may be used to carry electrical current, such as DC current, from an electrical source to a plurality of inverters 140 of a machine. As one example, the machine may be a locomotive 100, and the inverters 140 may be a plurality of traction inverters. Other applications for the busbar assembly 160 and busbar and inverter assembly described herein include mining vehicles, solar power arrangements, or any other electrically powered application where several inverters may be needed and can be arranged in parallel.

In use, the busbar and inverter assembly 105 may include four separate inverters arranged in parallel. FIG. 5 is a schematic diagram of current flowing through one of the busbar assemblies 160, shown in FIG. 2. Depiction of the other busbar assembly 160 shown in FIG. 2 is omitted for case of explanation. FIG. 5 shows the busbar assembly 160 from a side view, and shows the current source connection or port 165 for electrical connection to the current source 145, and the plurality of busbars 170, which receive current from the current source 145, such that the same amount of current flows through the busbars 170 to each of the inverters 140. The busbars 170 include the first busbar 170a, the second busbar 170b, and the third busbar 170c. The busbar assembly 160 further includes the plurality of spacers 175, positioned in between the busbars 170, in layers 180. FIG. 5 also shows the openings 185 in between the spacers 175 and the busbars 170, which allow dissipation of heat generated by current passing through the busbar assembly 160 to the inverters 140. Further, FIG. 5 shows the plurality of connectors 190, provided on the busbars 170. The connectors 190 provide for direct connection to the inverters 140, which may be arranged in parallel.

The amount of heat generated by the busbar assembly 160 is proportional to an amount of current flowing through the busbar assembly 160 and is inversely proportional to the surface area of the busbar assembly 160. The amount of heat generated by the busbar assembly also depends on the material used to form the busbars 170. A working temperature of the material used to form the busbar assembly 160 may, therefore, be used to determine the amount of current that the busbar assembly 160 may receive and transfer to the inverters 140. As a specific example, a busbar assembly 160 formed of copper may have a working temperature of about 120° C., so the dimensions of the busbar assembly 160 and the amount of current supplied to the busbar assembly 160 will be determined in order to avoid the busbar assembly 160 reaching that working temperature.

Because the plurality of busbars 170, the plurality of spacers 175, and the plurality of connectors 235 may be formed of the same conductive material, the current supplied by the current supply 145 via the current connection source 165 may be distributed among the busbars 170 and the spacers 175 evenly, and then flowing to the inverters 140, as shown by the straight arrows in FIG. 5. More specifically, the current flows from the current source 145 into the current source connection 165, through the busbars 170, from right to left as indicated by the sideward pointing and upward pointing straight arrows in FIG. 5, and then downward, as indicated by the downward pointing straight arrows in FIG. 5, toward the inverters 140. By virtue of the staggered arrangement of the busbars 170, the arrangement of the inverters 140 in parallel, and the direct connection between each of the inverters 140 and the busbars 170, each of the inverters 140 may draw about the same amount of current as the other inverters 140 (e.g., about 1000 A), while reducing a path of recirculating current, to that shown by arrows A in FIG. 5 for example.

By virtue of the busbar assembly 160, and, in particular, by virtue of the plurality of spacers 175 and the plurality of openings 185 of the busbar assembly 160, the busbar assemblies 160 have a relatively greater surface area, which facilitates providing greater convection area and dissipation of heat, which is generated when current flows through the plurality of busbars 170. The dissipation of heat, in turn, facilitates greater the thermal efficiency of the busbar and inverter assembly 105. In addition, using a plurality of busbars 170 separated by a plurality of spacers 175 provides more heat rejection area without requiring a relatively greater amount of copper. Still further, the busbars assembly 160 is relatively easy to manufacture, considering the staggered arrangement of the busbars 170, in cases in which only a length of each busbar 170 varies while the cross-sectional shape of the busbars 170 is the same. Further, the staggered arrangement of the busbars 170 combined with the use of the spacers 175 provide for relatively shorter paths for recirculating current, limiting the extent to which recirculating current flows towards the other inverters 140.

It will be apparent to those skilled in the art that various modifications and variations can be made to the disclosed busbar assemblies and busbar and inverter assemblies, without departing from the scope of the disclosure. Other embodiments of the busbar assemblies and busbar and inverter assemblies will be apparent to those skilled in the art from consideration of the specification and busbar assemblies and busbar and inverter assemblies disclosed herein. It is intended that the specification and examples be considered as exemplary only, with a true scope of the disclosure being indicated by the following claims and their equivalents.

What is claimed is:

1. A busbar assembly for delivering current to a plurality of inverters, the busbar assembly comprising:
a plurality of busbars, configured to receive current from a current source and to output current to the plurality of inverters;
a plurality of spacers positioned between the plurality of busbars; and
a plurality of inverter connectors, each inverter connector being coupled to one of the plurality of busbars,
wherein each of the plurality of spacers and the plurality of inverter connectors is formed of a conductive material.

2. The busbar assembly according to claim 1, wherein the plurality of busbars includes a first busbar, a second busbar, and a third busbar, and wherein a length of the third busbar is greater than a length of the second busbar, and the length of the second busbar is greater than a length of the first busbar.

3. The busbar assembly according to claim 2, wherein the plurality of spacers includes a first layer of spacers, including two or more spacers, between the first busbar and the second busbar, and a second layer of spacers, including two or more spacers between the second busbar and the third busbar.

4. The busbar assembly according to claim 2, further comprising a plurality of openings in between adjacent spacers of the plurality of spacers and in between adjacent busbars of the plurality of busbars, the plurality of openings allowing for dissipation of heat generated by current passing through the busbar assembly.

5. The busbar assembly according to claim 1, wherein the plurality of busbars, the plurality of spacers, and each inverter connector are brazed together to form the busbar assembly.

6. The busbar assembly according to claim 1, wherein spacers, of the plurality of spacers, have a same length, a same width, and a same height as each other.

7. The busbar assembly according to claim 1, wherein the conductive material is copper.

8. A busbar assembly comprising:
a plurality of busbars including:
a first busbar having a first length;
a second busbar having a second length that is greater than the first length; and
a third busbar having a third length that is greater than the second length;
a plurality of spacers forming:
a first spacer layer, including two or more spacers, of the plurality of spacers, positioned between the first busbar and the second busbar; and
a second spacer layer, including a number of spacers that is greater than a number of spacers of the first spacer layer, of the plurality of spacers, positioned between the second busbar and the third busbar; and
a plurality of inverter connectors, each inverter connector being coupled to one of the plurality of busbars,
wherein each spacer of the first spacer layer and the second spacer layer and the plurality of connectors is formed of a conductive material.

9. The busbar assembly according to claim 8, further comprising a plurality of openings defined by the spacers of the first spacer layer and the spacers of the second spacer layer, and by the first busbar, the second busbar, and the third busbar, the plurality of openings allowing for dissipation of heat generated by current passing through the busbar assembly.

10. The busbar assembly according to claim 8, wherein the plurality of busbars, the plurality of spacers, and the plurality of connectors are brazed together to form the busbar assembly.

11. The busbar assembly according to claim 8, wherein spacers, of the plurality of spacers, have a same length, a same width, and a same height as each other.

12. The busbar assembly according to claim 8, wherein the spacers of the first spacer layer, the spacers of the second spacer layer, and the plurality of inverter connectors have at least a same width.

13. The busbar assembly according to claim 8, wherein the conductive material is copper.

14. A busbar and inverter assembly, comprising:
a busbar assembly comprising:
a plurality of busbars, configured to receive current from a current source and to output current;
a plurality of spacers positioned between the plurality of busbars; and
a plurality of inverter connectors, each inverter connector being coupled to one of the plurality of busbars, each of the plurality of spacers and the plurality of connectors being formed of a conductive material; and
a plurality of inverters, arranged in parallel and directly connected to the plurality of inverter connectors and configured to receive the current output by the plurality of busbars.

15. The busbar and inverter assembly of claim 14, wherein the plurality of busbars includes a first busbar, a second busbar, and a third busbar, and wherein a length of the third busbar is greater than a length of the second busbar, and the length of the second busbar is greater than a length of the first busbar.

16. The busbar and inverter assembly of claim 14, wherein the plurality of spacers includes a first layer of spacers, including two or more spacers, between the first busbar and the second busbar, and a second layer of spacers, including two or more spacers between the second busbar and the third busbar.

17. The busbar and inverter assembly according to claim 14, wherein the busbar assembly includes a plurality of openings in between adjacent spacers of the plurality of spacers and in between adjacent busbars of the plurality of busbars, the plurality of openings allowing for dissipation of heat generated by current passing through the busbar assembly.

18. The busbar and inverter assembly according to claim 14, wherein the plurality of busbars, the plurality of spacers, and the plurality of connectors are brazed together to form the busbar assembly that is connected to the plurality of inverters.

19. The busbar and inverter assembly according to claim 14, wherein spacers, of the plurality of spacers, have a same length, a same width, and a same height as each other.

20. The busbar and inverter assembly according to claim 14, wherein the conductive material is copper.
